(19) United States
(12) Patent Application Publication
(10) Pub. No.: US 2013/0006953 A1
(43) Pub. Date: Jan. 3, 2013

(54) SPATIALLY ORGANIZED IMAGE COLLECTIONS ON MOBILE DEVICES

(75) Inventors: BORIS EPSHTEIN, Bothell, WA (US); EYAL OFEK, Redmond, WA (US)

(73) Assignee: MICROSOFT CORPORATION, Redmond, WA (US)

(21) Appl. No.: 13/172,490

(22) Filed: Jun. 29, 2011

(51) Int. Cl. G06F 17/30; G09G 5/00; G06Q 30/00

(52) U.S. Cl. 707/706; 705/14.4; 345/656; 707/E17.108

(57) ABSTRACT

Systems, methods, and computer-readable media for, among other things, spatially-organizing images utilizing information about the orientation of each image for display on mobile devices are provided. A plurality of images of an object is captured from a variety of different orientations and each image and its associated respective orientation information are stored in an image file. Upon a device receiving an indication that displaying of the image file is desired, the device detects the orientation thereof and displays the image of the plurality of images that has orientation information associated therewith that most closely matches the orientation of the device. As the orientation of the device changes, the image that is displayed also changes, approximating for a user viewing the image file the experience of three-dimensional viewing of the object. Such image files may also be utilized in association with advertisements and as search queries.

### BACKGROUND

Today, many people have highly equipped handheld mobile devices, with a good number being equipped with cameras, accelerometers, object displays, and the like. Such devices are heavily utilized for communication, including communication about various objects. For instance, users often come across objects in their daily activities that may be of interest to them. In today's highly socially-connected environment, it would not be unusual for the user to communicate about the object with a friend or family member before, e.g., making a purchase decision. One common method of communicating about the object is for the user to take a photograph of the object utilizing his or her camera-equipped mobile device and to send the photograph to the friend or family member for viewing. While such a method does provide the friend or family member with some useful information about the object in question, it is somewhat limited in that most objects in today's world are three-dimensional and a photograph remains a two-dimensional means of communication.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable media for, among other things, spatially-organizing images utilizing information about the orientation of each image for display on mobile devices. A first user, utilizing a mobile device equipped with a camera and the ability to detect an orientation of the device at the time an image is captured (e.g., an accelerometer and/or a gyroscope), captures a plurality of images of a particular object from a variety of different orientations. Each image and its associated respective orientation information are stored in an image file. The first user then sends the image file to a second mobile device equipped with image display and orientation-detection capabilities. The second mobile device, upon receiving an indication that displaying of the image file is desired, detects the orientation of the second mobile device and displays the image of the plurality of images that has orientation information associated therewith that most closely matches the orientation of the second mobile device. As the orientation of the second mobile device changes, the image of the plurality of images that is displayed also changes, approximating for the user viewing the image file the experience of three-dimensional viewing of the object. Embodiments may be similarly applied to capture and playback of directional audio, depth images, and the like.

### BRIEF DESCRIPTION OF THE DRAWINGS

The present invention is illustrated by way of example and not limited in the accompanying figures in which like reference numerals indicate similar elements and in which:

FIG. 1 is a block diagram of an exemplary computing environment suitable for use in implementing embodiments of the present invention;

FIG. 2 is a block diagram of an exemplary computing system in which embodiments of the invention may be employed;

FIGS. 3A and 3B are collectively a flow diagram showing methods for displaying spatially-organized images on mobile devices, in accordance with an embodiment of the present invention;

FIG. 4 is a flow diagram showing a method for utilizing spatially-organized images in association with advertisements, in accordance with another embodiment of the present invention; and

FIG. 5 is a flow diagram showing a method for utilizing spatially-organized images as search queries, in accordance with another embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable media for, among other things, spatially-organizing images utilizing information about the orientation of each image for display on mobile devices. Those of ordinary skill in the art will understand that embodiments may be similarly applied to capture and playback of directional audio, depth images, and the like, and that applications hereof are not limited only to two-dimensional images. A first user, utilizing a mobile device equipped with a camera and the ability to detect an orientation of the device at the time an image is captured (e.g., an accelerometer and/or a gyroscope), captures a plurality of images of a particular object from a variety of different orientations. Each image and its associated respective orientation information are stored in an image file. The first user then sends the image file to a second mobile device equipped with image display and orientation-detection capabilities. The second mobile device, upon receiving an indication that displaying of the image file is desired, detects the orientation of the second mobile device and displays the image of the plurality of images that has orientation information associated therewith that most closely matches the orientation of the second mobile device. As the orientation of the second mobile device changes, the image of the plurality of images that is displayed also changes, approximating for the user viewing the image file the experience of three-dimensional viewing of the object. Such image files may also be utilized in association with advertisements and as search queries, as more fully described below.

Embodiments of the present invention permit the user of the second mobile device to view the captured images by recreating the poses or photograph-capturing pattern of the user of the first, or capturing, mobile device. That is, if the first user captures the plurality of images of the particular object by creating a sphere around the object, as the images are displayed on the second mobile device, the steps of the user of the first mobile device can be recreated. Similarly, the first user may stand in a relatively stable location and take a plurality of images in a panorama around his or herself. This experience, upon being viewed by the user of the second mobile device, can also be recreated. Similarly, a general manifold may be created by the first user if he or she, for instances, moves into a building or the like. In embodiments, a display on the second mobile device may indicate the available directions or orientations for which images were captured and, thus, from which orientations images are available for viewing.

Accordingly, one embodiment of the present invention is directed to one or more computer-readable storage media storing computer-useable instructions that, when used by one or more computing devices, cause the one or more computing devices to perform a method for displaying spatially-organized images on mobile devices. The method includes receiving, on a first mobile device, a plurality of images of a particular item, each of the plurality of images being associated with respective orientation information. The method further includes detecting a first orientation of the first mobile device and, using the respective orientation information for each of the plurality of images, determining a first of the plurality of images that is associated with respective orientation information that is closest to the detected first orientation of the first mobile device. Still further, the method includes displaying the first of the plurality of images on a display screen associated with the first mobile device.

Another embodiment of the present invention is directed to method performed by a computing device having a processor and a memory for utilizing spatially-organized images in association with advertisements. The method includes receiving a plurality of images of a particular item, each of the plurality of images being associated with respective orientation information. The method further includes processing the plurality of images, wherein the processing includes associating at least a first portion of the plurality of images and respective associated orientation information with an advertisement. Still further, the method includes receiving a request for the advertisement and transmitting the advertisement and the associated at least a first portion of the plurality of images and respective associated orientation information for display on a first mobile device such that a change in the orientation of the mobile device causes a different image of the at least a first portion of the plurality of images to be displayed on the first mobile device in association with the advertisement.

In yet another embodiment, the present invention is directed to one or more computer-readable storage media storing computer-useable instructions that, when used by one or more computing devices, cause the one or more computing devices to perform a method for utilizing spatially-organized images as search queries. The method includes receiving a plurality of images of a particular item as a search query, each of the plurality of images being associated with respective orientation information. The method further includes determining one or more search results that correspond with the particular item utilizing the plurality of images and the associated respective orientation information and transmitting the one or more search results for presentation.

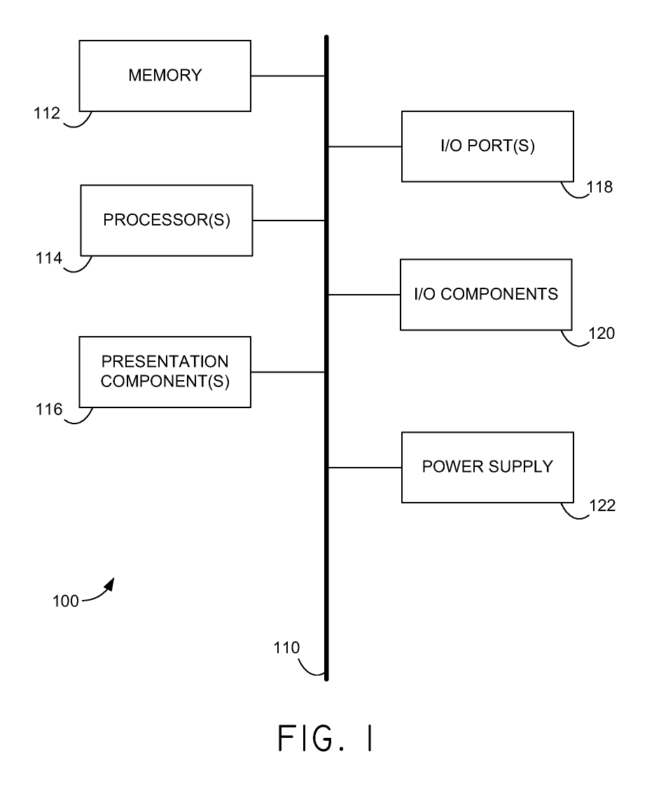

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media can be any available media that can be accessed by the computing device 100 and includes both volatile and nonvolatile media, removable and non-removable media implemented in any method or technology for storage of information such as computer-readable instructions, data structures, program modules or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, and the like.

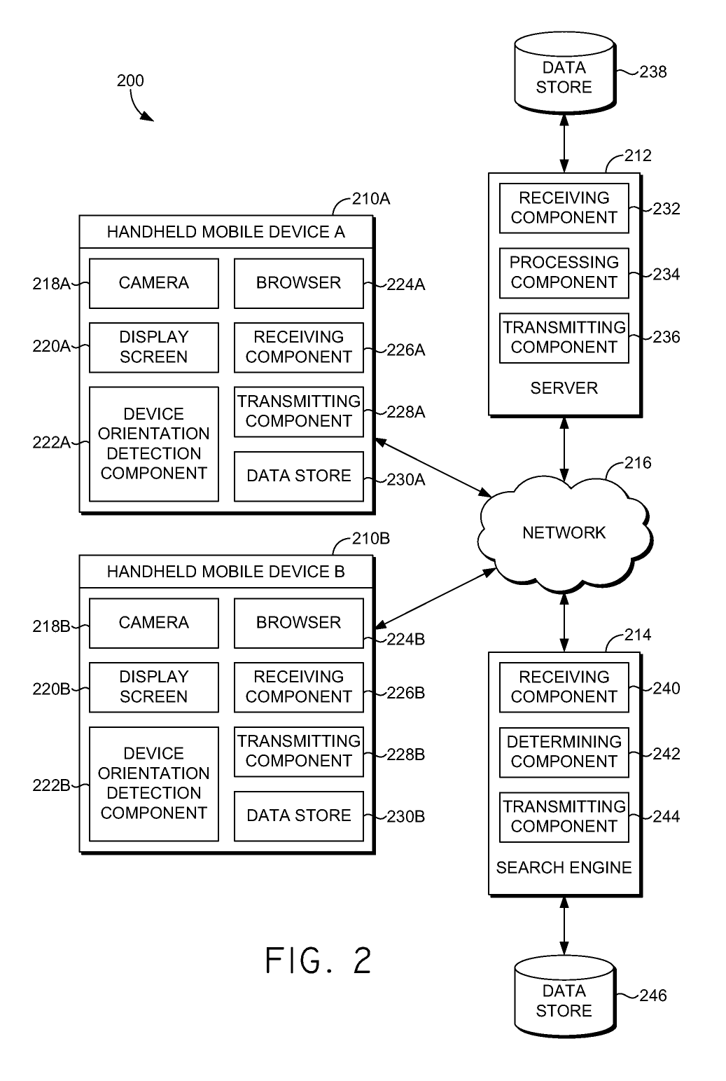

As previously mentioned, the current invention relates to systems, methods, and computer-readable media for spatially-organizing a plurality of images of an object (as well as, e.g., directional audio files, depth images and the like) utilizing information about the orientation of each image for presentation on mobile devices. Referring now to FIG. 2, a block diagram is provided illustrating an exemplary computing system 200 in which embodiments of the present invention may be employed. Generally, the computing system 200 illustrates an environment in which a plurality of images of an object is captured from a variety of different orientations and each image and its associated respective orientation information are stored in an image file. Upon a device receiving an indication that displaying of the image file is desired, the device detects the orientation thereof and displays the image of the plurality of images that has orientation information associated therewith that most closely matches the orientation of the device. As the orientation of the device changes, the image that is displayed also changes, approximating for a user viewing the image file the experience of three-dimensional viewing of the object. As will be described in further detail below, such image files may also be utilized in association with advertisements and as search queries, as more fully described below.

Among other components not shown, the computing system 200 generally includes a first hand-held mobile computing device 210A, a second hand-held mobile device 210B, a server, and a search engine 214, all in communication with one another via a network 218. The network 218 may include, without limitation, one or more local area networks (LANs) and/or wide area networks (WANs). Such networking environments are commonplace in offices, enterprise-wide computer networks, intranets and the Internet. Accordingly, the network 218 is not further described herein.

It should be understood that any number of hand-held mobile computing devices, servers and search engines may be employed in the computing system 200 within the scope of embodiments of the present invention. Each may comprise a single device/interface or multiple devices/interfaces cooperating in a distributed environment. For instance, the server 212 and/or the search engine 214 may comprise multiple devices and/or modules arranged in a distributed environment that collectively provide the respective functionality of the server 212 and/or search engine 214 described herein. Additionally, other components/modules not shown may also be included within the computing system 200.

In some embodiments, one or more of the illustrated components/modules may be implemented as stand-alone applications. In other embodiments, one or more of the illustrated components/modules may be implemented via one of the hand-held mobile computing devices 210A, 210B, as an Internet-based service, or as a module inside the server 212 or the search engine 214. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of servers, search engines, or hand-held mobile computing devices. By way of example only, the search engine 214 might reside on a server, cluster of servers, or a computing device (not shown) remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Each of the hand-held mobile computing devices 210A, 210B may include any type of computing device, such as computing device 100 described with reference to FIG. 1, for example. As illustrated, each of the hand-held mobile computing devices 210A, 210B includes a respective camera 218A, 218B, display screen 220A, 220B, device orientation detection component 222A, 222B, browser 224A, 224B, receiving component 226A, 226B, transmitting component 228A, 228B, and data store 230A, 230B. It should be noted that for ease of description, when any of the components of hand-held mobile devices 210A and 210B is described herein merely by the base reference numeral (e.g., 210) rather than the specific delineated device or component reference numeral (e.g., 210A or 210B), such is indicative that the described device or component is the same for both hand-held mobile devices 210A, 210B.

The camera 218 is configured to capture a plurality of images of a particular item. Generally, a user of the hand-held mobile device 210, upon coming across a three-dimensional object of interest, utilizes the camera 218 to capture a plurality of images of the object of interest, each of the plurality of images being captured at a different angle or orientation with respect to the object.

The display screen 220 is configured to display captured images, as well as any other text or information the user desires to view. For instance, the display screen 220 is configured to display advertisement text and images, search query input areas, search results (text and images), and any additional information visually available to the user. In embodiments, the display screen 220 may be further configured to indicate the available directions or orientations for which images are available for viewing.

The device orientation detection component 222 is configured to detect the orientation of the hand-held device 210. For instance, upon the user capturing an image utilizing the camera 218, the device orientation detection component 222 detects the orientation of the mobile device 210 so that such orientation information can be associated with the captured image. Similarly, upon a user viewing an image file comprising a plurality of images, each image having respective associated orientation information, the orientation detection component 222 is configured to detect the orientation of the hand-held mobile device 210 so that the image having orientation information that is closest to the detected orientation of the mobile device 210 may be selected for presentation (e.g., in association with the display screen 220 of the mobile device 210). In accordance with embodiments of the present invention, the device orientation detection component 222 may include an accelerometer, a gyroscope, or any other device or component capable of detecting orientation of the hand-held mobile device 210. Any and all such variations, and any combination thereof, are contemplated to be within the scope of embodiments hereof.

The browser 224 is configured to provide an interface through which the user of the hand-held mobile device 210 may transmit and receive image files and other available information. In embodiments, the browser 224 is configured to provide an interface through which search queries comprising image files having a plurality of images of an object, each with associated respective orientation information, may be input and to render the results of input search queries in association with the display screen 220 of the hand-held mobile computing device 210. While search results are described as being provided and presented, it is straightforward for the computing system 200 to provide a link or other reference by which the user may retrieve the relevant result(s). Note that the link need not be followed by a conventional browser 224; for example, an application residing on or accessed by the hand-held mobile computing device 210 can follow the link, obtain the search result(s), and insert a representation of the search result(s) into its output. Further, the functionality described herein as being performed by the browser 224 may be performed by any other application capable of rendering web content. Any and all such variations, and any combination thereof, are contemplated to be within the scope of embodiments of the present invention.

The receiving component 226 is configured to receive image files comprised of a plurality of images of a particular object, each of the plurality of images having associated respective orientation information. Similarly, the transmitting component 228 is configured to transmit images files comprised of a plurality of images of a particular object, each of the plurality of images having associated respective orientation information. In embodiments, the receiving component 226 and the transmitting component 228 are further configured to receive and transmit, respectively, search queries, advertisements, and the like.

The data store 230 is configured to store images and associated respective orientation information. In various embodiments, such information may include, without limitation, images files comprised of a plurality of images of a particular object, each of the plurality of images having respective associated orientation information. In embodiments, the data store 230 is configured to be searchable for one or more of the items stored in association therewith. It will be understood and appreciated by those of ordinary skill in the art that the information stored in association with the data store 230 may be configurable and may include any information relevant to captured images, hand-held mobile device orientation information, and/or the like. The content and volume of such information are not intended to limit the scope of embodiments of the present invention in any way. Further, though illustrated as a single, independent component, the data store 230 may, in fact, be a plurality of storage devices, for instance a database cluster, portions of which may reside in association with the hand-held mobile computing device 210, another external computing device (not shown), and/or any combination thereof.

With continued reference to FIG. 2, the server 212 may include any type of computing device, such as computing device 100 described with reference to FIG. 1, for example. As illustrated, the server 212 includes a receiving component 232, a processing component 234 and a transmitting component 236. The server 212 also includes or has access to a data store 238. The data store 238 is configured to images, processed images, and associated respective orientation information. In various embodiments, such information may include, without limitation, images files comprised of a plurality of images of a particular object (some or all of which may include process enhancements), each of the plurality of images having respective associated orientation information. In embodiments, the data store 238 is configured to be searchable for one or more of the items stored in association therewith. It will be understood and appreciated by those of ordinary skill in the art that the information stored in association with the data store 238 may be configurable and may include any information relevant to captured images, hand-held mobile device orientation information associated with captured images, and/or the like. The content and volume of such information are not intended to limit the scope of embodiments of the present invention in any way. Further, though illustrated as a single, independent component, the data store 238 may, in fact, be a plurality of storage devices, for instance a database cluster, portions of which may reside in association with the server 212, another external computing device (not shown), and/or any combination thereof.

The receiving component 232 is configured to receive images from a user (for instance, utilizing the hand-held mobile computing device 210), the images including respective associated orientation information. Typically, the images are received via a browser associated with the user computing device, for instance, the browser 224 associated with the hand-held mobile computing device 210. The receiving component 232 is further configured to receive requests for images having associated orientation information.

The processing component 234 is configured to process images received by the server, for instance, from one of the hand-held mobile computing devices 210A, 210B. Such processing may include, without limitation, compressing image, annotating images and providing various visual enhancements to the images. Such visual enhancements may include, without limitation, vision-based image matching to refine the positions of the images (reducing sensor errors), color correction (manual or automatic), view interpolation for a smoother viewing experience or to fill in missing views (using view interpolation between existing views), removing irregularities (outlier images), and/or super-resolution for better image quality. Processing of images may further include associating one or more images and their respective associated orientation information with an advertisement. Any and all such variations, and any combination thereof, are contemplated to be within the scope of embodiments of the present invention.

The transmitting component 236 is configured to transmit images (whether processed or not) and respective associated orientation information (e.g., via the network 216) to a requesting device, for instance, hand-held mobile computing device 210 for display. In embodiments, such images and the respective associated orientation information are transmitted via a single image file upon request.

With continued reference to FIG. 2, the search engine 214 may be any search engine capable of searching text and/or content. Those skilled in the art will recognize that the present invention may be implemented with any number of searching utilities. For example, an Internet search engine or a database search engine may utilize the present invention. These search engines are well known in the art, and commercially available engines share many similar processes.

As illustrated, the search engine 214 includes a receiving component 240, a search results determining component 242 and a transmitting component 244. The search engine 214 also includes or has access to a data store 246. The data store 246 is configured to store, for instance, indexed information that is accessible for matching search results to search queries, and the like. In embodiments, the data store 246 is configured to be searchable for one or more of the items stored in association therewith. It will be understood and appreciated by those of ordinary skill in the art that the information stored in association with the data store 246 may be configurable and may include any information relevant to received search queries, search results, user behavior with respect to search results, and/or the like. The content and volume of such information are not intended to limit the scope of embodiments of the present invention in any way. Further, though illustrated as a single, independent component, the data store 246 may, in fact, be a plurality of storage devices, for instance a database cluster, portions of which may reside in association with the hand-held mobile computing device 210, another external computing device (not shown), and/or any combination thereof.

The receiving component 240 is configured to receive a query input by a user (for instance, utilizing the hand-held mobile computing device 210), the query including an image file and requesting satisfying search results. Typically, the search query is received via a browser associated with the user computing device, for instance, the browser 224 associated with the hand-held mobile computing device 210. In accordance with embodiments of the present invention, the image file received in association with a received query includes a plurality of images of an object, each of the plurality of images having respective associated orientation information.

The search results determining component 242 is configured to determine a plurality of search results satisfying the input search query. In embodiments, such satisfying search results are determined utilizing a data store (e.g., data store 246) configured to store indexed electronic documents. Techniques for determining search results that are determined to satisfy input search queries are well known to those of ordinary skill in the art and, accordingly, are not further described herein. Generally, the search results determining component 242 determines an HTML response that contains the search results that are determined to satisfy the search query. The transmitting component 244 is configured to transmit determined search results (e.g., via the network 216) to the requesting device, for instance, hand-held mobile computing device 210 for display.

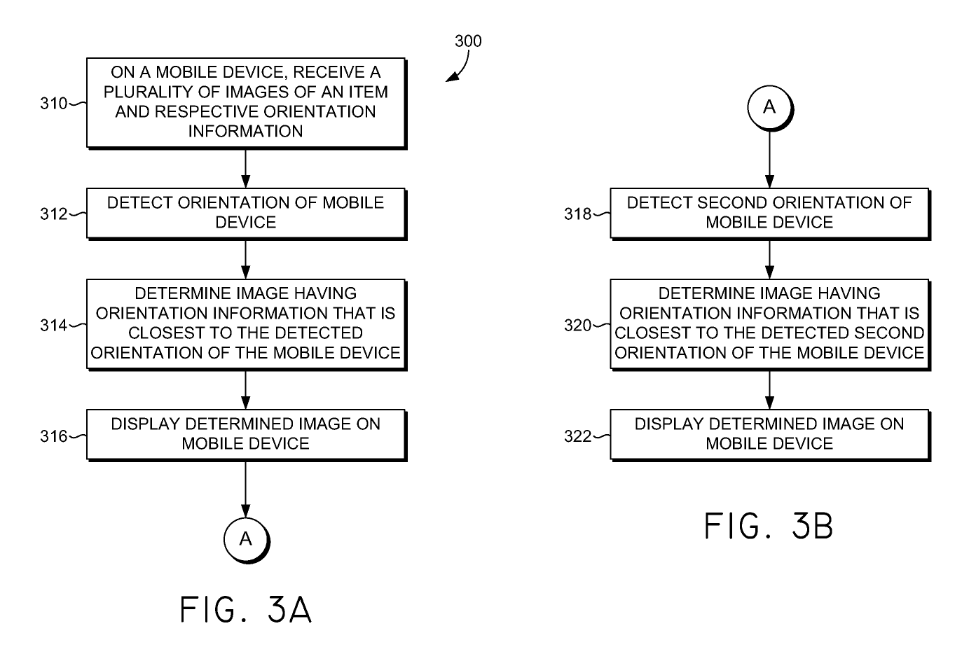

Turning now to FIG. 3A, a flow diagram is provided that illustrates a method 300 for displaying spatially-organized images on mobile devices, in accordance with an embodiment of the present invention. As indicated at block 310, a plurality of images of a particular item is received on a mobile device, the mobile device having image display and orientation-detecting capabilities. Each of the plurality of images is associated with respective orientation information. As indicated at block 312, a first orientation of the mobile device is then detected. Using the respective orientation information for each of the plurality of images, a first of the plurality of images that is associated with respective orientation information that is closest to the detected first orientation of the mobile device is determined, as indicated at block 314. The first of the plurality of images is then displayed, for instance, on a display screen associated with the mobile device. This is indicated at block 316.

With reference to FIG. 3B, an embodiment of the method 300 for displaying spatially-organized images upon a change in the orientation of the displaying mobile device is shown. As indicated at block 318, a second orientation of the mobile device is detected, for instance, utilizing the orientation-detecting capability (e.g., accelerometer, gyroscope, and/or the like) of the mobile device. Using the respective orientation information for each of the plurality of images, a second of the plurality of images is determined, the second image having respective associated orientation information that is closest to the detected second orientation of the mobile device. This is indicated at block 320. The second of the plurality of images is then displayed, for instance, on a display screen associated with the mobile device, as indicated at block 322.

Turning now to FIG. 4, a flow diagram is provided that illustrates a method 400 for utilizing spatially-organized images in association with advertisements, in accordance with another embodiment of the present invention. As indicated at block 410, a plurality of images of a particular item is received, each of the plurality of images being associated with respective orientation information. As indicated at block 412, the plurality of images is processed such that at least a portion of the plurality of images, and its respective associated orientation information, is associated with an advertisement. A request for the advertisement is then received, as indicated at block 414. The advertisement, the portion of the plurality of images, and the respective associated orientation information is transmitted for display on a mobile device, as indicated at block 416, such that a change in the orientation of the mobile device causes a different image of the transmitted images to be displayed.

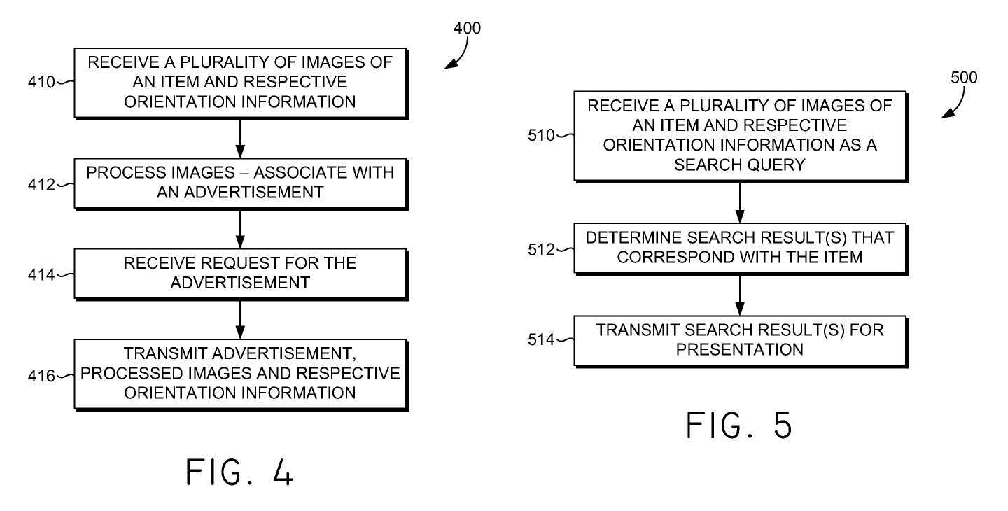

With reference to FIG. 5, a flow diagram is provided that illustrates a method 500 for utilizing spatially-organized images as search queries, in accordance with an embodiment of the present invention. As indicated at block 510, a plurality of images of a particular item is received as a search query, each of the plurality of images being associated with respective orientation information. As indicated at block 512, one or more search results that correspond with the particular item are then determined utilizing the plurality of images and the associated respective orientation information. The one or more search results are then transmitted for presentation in association with a mobile device, as indicated at block 514.

As can be understood, embodiments of the present invention provide systems and methods for spatially-organizing images, directional audio files, depth images, and the like, utilizing information about the orientation of each image/audio file/depth image/etc. for presentation on mobile devices. The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the method 300 of FIGS. 3A and 3B, the method 400 of FIG. 4, and the method 500 of FIG. 5 are not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. One or more computer-readable storage media storing computer-useable instructions that, when used by one or more computing devices, cause the one or more computing devices to perform a method for displaying spatially-organized images on mobile devices, the method comprising:
receiving, on a first mobile device, a plurality of images of a particular item, each of the plurality of images being associated with respective orientation information;
detecting a first orientation of the first mobile device;
using the respective orientation information for each of the plurality of images, determining a first of the plurality of images that is associated with respective orientation information that is closest to the detected first orientation of the first mobile device; and
displaying the first of the plurality of images on a display screen associated with the first mobile device.

2. The one or more computer-readable storage media of claim 1, wherein the method further comprises:
detecting a second orientation of the first mobile device;
using the respective orientation information for each of the plurality of images, determining a second of the plurality of images that is associated with respective orientation information that is closest to the detected second orientation of the first mobile device; and
displaying the second of the plurality of images on the display screen associated with the first mobile device.

3. The one or more computer-readable storage media of claim 1, wherein receiving the plurality of images of a particular item comprises receiving the plurality of images and respective associated orientation information as a single file.

4. The one or more computer-readable storage media of claim 1, wherein receiving the plurality of images of the particular item comprises receiving the plurality of images of the particular item from a second mobile device.

5. The one or more computer-readable storage media of claim 1, wherein receiving the plurality of images of the particular item comprises receiving the plurality of images of the particular item in association with an advertisement.

6. The one or more computer-readable storage media of claim 1, wherein at least a portion of the plurality of images of the particular item has been compressed.

7. The one or more computer-readable storage media of claim 1, wherein at least a portion of the plurality of images of the particular item has been annotated.

8. The one or more computer-readable storage media of claim 1, wherein at least a portion of the plurality of images of the particular item has been visually enhanced.

9. The one or more computer-readable storage media of claim 1, wherein the at least a portion of the plurality of images of the particular item has been visually enhanced utilizing one or more of vision-based image matching, color correction, view interpolation, irregularity removal and super-resolution.

10. The one or more computer-readable storage media of claim 1, wherein the method further comprises:
transmitting the plurality of images of the particular item to a search engine as a search query; and
receiving one or more search results that correspond with the particular item.

11. The one or more computer-readable storage media of claim 1, wherein detecting the first orientation of the first mobile device comprises detecting the first orientation of the first mobile device utilizing at least one of an accelerometer and a gyroscope.

12. A method performed by a computing device having a processor and a memory for utilizing spatially-organized images in association with advertisements, the method comprising:
receiving a plurality of images of a particular item, each of the plurality of images being associated with respective orientation information;
processing the plurality of images, wherein the processing includes associating at least a first portion of the plurality of images and respective associated orientation information with an advertisement;
receiving a request for the advertisement; and
transmitting the advertisement and the associated at least a first portion of the plurality of images and respective associated orientation information for display on a first mobile device such that a change in the orientation of the mobile device causes a different image of the at least a first portion of the plurality of images to be displayed on the first mobile device in association with the advertisement.

13. The method of claim 12, wherein receiving the plurality of images of the particular item comprises receiving the plurality of images of the particular item and the respective associated orientation information from a second mobile device.

14. The method of claim 12, wherein receiving the plurality of images of the particular item comprises receiving the plurality of images and respective associated orientation information as a single file

15. The method of claim 12, wherein processing the plurality of images further includes compressing at least a second portion of the plurality of images.

16. The method of claim 12, wherein processing the plurality of images further includes annotating at least a second portion of the plurality of images.

17. The method of claim 12, wherein processing the plurality of images further includes visually enhancing at least a second portion of the plurality of images.

18. The method of claim 17, wherein visually enhancing at least the second portion of the plurality of images includes one or more of vision-based image matching, color correction, view interpolation, irregularity removal and super-resolution of the at least the second portion of the plurality of images.

19. One or more computer-readable storage media storing computer-useable instructions that, when used by one or more computing devices, cause the one or more computing devices to perform a method for utilizing spatially-organized images as search queries, the method comprising:
receiving a plurality of images of a particular item as a search query, each of the plurality of images being associated with respective orientation information;
determining one or more search results that correspond with the particular item utilizing the plurality of images and the associated respective orientation information; and
transmitting the one or more search results for presentation.

20. The one or more computer-readable storage media of claim 19, wherein receiving the plurality of images of the particular item comprises receiving the plurality of images and respective associated orientation information as a single file.
